(19) United States
(12) Patent Application Publication
(10) Pub. No.: US 2023/0167024 A1
(43) Pub. Date: Jun. 1, 2023

(54) SEALED GLASS PACKAGES AND METHOD OF MAKING SAME

(71) Applicant: CORNING INCORPORATED, Corning, NY (US)

(72) Inventors: Stephan Lvovich Logunov, Corning, NY (US); Mark Alejandro Quesada, Horseheads, NY (US); Farrokh Sheibani, Newton, MA (US)

(21) Appl. No.: 17/994,820

(22) Filed: Nov. 28, 2022

Related U.S. Application Data
(60) Provisional application No. 63/284,132, filed on Nov. 30, 2021.

(51) Int. Cl. C03C 27/10; G02B 3/12

(52) U.S. Cl. CPC C03C 27/10; G02B 3/12

(57) ABSTRACT

A sealed glass package includes a top substrate and a bottom substrate, each of the top substrate and the bottom substrate comprising a first major surface and a second major surface opposite the first major surface; a central substrate disposed between the second major surface of the top substrate and the first major surface of the bottom substrate, the central substrate including a cavity filled by a first liquid and a second liquid; a polymer disposed between the second major surface of the top substrate and the central substrate; a first laser bond joining and hermetically sealing the first major surface of the bottom substrate and the central substrate; and a second laser bond joining and hermetically sealing the second major surface of the top substrate and the central substrate.

### CROSS-REFERENCE TO RELATED APPLICATIONS

This application claims the benefit of priority under 35 U.S.C. § 119 of U.S. Provisional Application No. 63/284,132, filed Nov. 30, 2021, the content of which is incorporated herein by reference in its entirety.

### FIELD

The present specification generally relates to sealed glass packages and, in particular, to sealed glass packages including a polymer and a laser bond.

### Technical Background

Sealed glass packages (e.g., liquid lenses) may be utilized for a wide range of applications, including autofocus, optical zoom, and optical image stabilization functions. Substrates may surround and encapsulate liquids in the sealed glass package, preventing those liquids from escaping the sealed glass package. Conventional sealed glass packages may not have sufficient burst pressure and may be formed via methods that do not have high manufacturing yields.

Accordingly, a need exists for an alternative sealed glass packages having sufficient burst pressure and formed using a high yield method.

### SUMMARY

According to a first aspect Al, a sealed glass package may comprise: a top substrate and a bottom substrate, each of the top substrate and the bottom substrate comprising a first major surface and a second major surface opposite the first major surface; a central substrate disposed between the second major surface of the top substrate and the first major surface of the bottom substrate, the central substrate including a cavity filled by a first liquid and a second liquid; a polymer disposed between the second major surface of the top substrate and the central substrate; a first laser bond joining and hermetically sealing the first major surface of the bottom substrate and the central substrate; and a second laser bond joining and hermetically sealing the second major surface of the top substrate and the central substrate.

A second aspect A2 includes the sealed glass package according to the first aspect A1, wherein the sealed glass package comprises a burst pressure greater than or equal to 500 kPa.

A third aspect A3 includes the sealed glass package according to the first aspect A1 or second aspect A2, wherein at least one of the first laser bond and the second laser bond is contiguous along a perimeter of the sealed glass package.

A fourth aspect A4 includes the sealed glass package according to the first aspect A1 or second aspect A2, wherein at least one of the first laser bond and the second laser bond is discontinuous along a perimeter of the sealed glass package.

A fifth aspect A5 includes the sealed glass package according to any one of the first through fourth aspects A1-A4, wherein at least one of the first laser bond and the second laser bond comprises a width greater than or equal to 8 µm and less than or equal to 500 µm.

A sixth aspect A6 includes the sealed glass package according to any one of the first through fifth aspects A1-A5, wherein the polymer is in the form of an O-ring.

A seventh aspect A7 includes the sealed glass package according to any one of the first through sixth aspects A1-A6, wherein the polymer is in a state of compression, forming a seal between the top substrate and the central substrate.

An eighth aspect A8 includes the sealed glass package according to any one of the first through seventh aspects A1-A7, wherein the polymer comprises fluoroelastomer, nitrile rubber, silicone, butadiene, neoprene, polydimethylsiloxane, or a combination thereof.

A ninth aspect A9 includes the sealed glass package according to any one of the first through eighth aspects A1-A8, wherein the polymer comprises a loss coefficient tan(δ) greater than or equal to 0.1.

A tenth aspect A10 includes the sealed glass package according to any one of the first through ninth aspects A1-A9, wherein the polymer comprises a Young’s modulus E less than or equal to 2000 MPa.

An eleventh aspect A11 includes the sealed glass package according to any one of the first through tenth aspects A1-A10, wherein the polymer comprises a sound absorption coefficient α greater than or equal to 0.5.

A twelfth aspect A12 includes the sealed glass package according to any one of the first through eleventh aspects A1-A11, wherein the polymer comprises fillers, the fillers comprising nanofillers, hollow glass spheres, or a combination thereof.

A thirteenth aspect A13 includes the sealed glass package according to the twelfth aspect A12, wherein the nanofillers comprise carbon nanotubes.

A fourteenth aspect A14 includes the sealed glass package according to any one of the first through thirteenth aspects A1-A13, wherein the polymer comprises a roughened outer surface having a tortuosity greater than 1.

A fifteenth aspect A15 includes the sealed glass package according to any one of the first through fourteenth aspects A1-A14, wherein the top substrate comprises a groove within which the polymer is positioned.

A sixteenth aspect A16 includes the sealed glass package according any one of the first through fifteenth aspects A1-A15, wherein the top substrate and the bottom substrate each comprise a thickness greater than or equal to 100 µm and less than or equal to 700 µm.

A seventeenth aspect A17 includes the sealed glass package according to any one of the first through sixteenth aspects A1-A16, wherein the central substrate comprises a thickness greater than or equal to 500 µm and less than or equal to 1300 µm.

An eighteenth aspect A18 includes the sealed glass package according to any one of the first through seventeenth aspects A1-A17, wherein the sealed glass package comprises a thickness from the first major surface of the top substrate to the second major surface of the bottom substrate greater than or equal to 0.3 mm and less than or equal to 10 mm.

A nineteenth aspect A19 includes the sealed glass package according to any one of the first through eighteenth aspects A1-A18, wherein the top substrate, the bottom substrate, and the central substrate comprise a glass or glass-ceramic comprising borate glass, silicoborate glass, phosphate-based glass, silicon carbide glass, soda-lime silicate glass, aluminosilicate glass, alkali-aluminosilicate glass, borosilicate glass, alkali-borosilicate glass, aluminoborosilicate glass, alkali-alumino-borosilicate glass, or alkali-aluminosilicate glass.

A twentieth aspect A20 includes the sealed glass package according to any one of the first through nineteenth aspects A1-A19, wherein the sealed glass package comprises a liquid lens.

According to a twenty-first aspect A21, a method of forming a sealed glass package may comprise: contacting a first major surface of a bottom substrate with a second major surface of a central substrate to create a first contact location between at least a portion of the first major surface of the bottom substrate and the second major surface of the central substrate; conducting a first bonding step by directing a laser beam on at least a portion of the first contact location to bond the bottom substrate to the central substrate and form a first laser bond joining and hermetically sealing the first major surface of the bottom substrate and the second major surface of the central substrate; disposing a polymer on a first major surface of the central substrate; filling a cavity of the central substrate with a first liquid and a second liquid; contacting a second major surface of a top substrate with the first major surface of the central substrate to create a second contact location between at least a portion of the second major surface of the top substrate and the first major surface of the central substrate; and conducting a second bonding step by directing the laser beam on at least a portion of the second contact location to bond the top substrate to the central substrate and form a second laser bond joining and hermetically sealing the second major surface of the top substrate and the first major surface central substrate.

A twenty-second aspect A22 includes the method according to the twenty first aspect A21, wherein the laser beam has a spot size greater than or equal to 10 µm and less than or equal to 200 µm.

A twenty-third aspect A23 includes the method according to the twenty-first aspect A21 or twenty-second aspect A22, wherein the laser beam has a speed of beam translation greater than or equal to 20 mm/s and less than or equal to 1 m/s.

A twenty-fourth aspect A24 includes the method according to any one of the twenty-first trough twenty-third aspects A21-A23, wherein the laser beam has a laser power greater than or equal to 10 mW and less than or equal to 3 W.

A twenty-fifth aspect A25 includes the method according to any one of the twenty-first through twenty-fourth aspects A21-A24, wherein the laser beam comprises a continuous wave laser.

A twenty-sixth aspect A26 includes the method according to any one of the twenty-first through twenty-fourth aspects A21-A24, wherein the laser beam comprises a pulsed laser.

A twenty-seventh aspect A27 includes the method according to the twenty-sixth aspect A26, wherein the pulsed laser has a repetition rate greater than or equal to 1 kHz and less than or equal to 1 MHz.

A twenty-eighth aspect A28 includes the method according to any one of twenty-first through twenty-seventh aspects A21-A27, wherein during contacting the second major surface of the top substrate with the first major surface of the central substrate, the polymer is compressed.

A twenty-ninth aspect A29 includes the method according to any one of twenty-first through twenty-eighth aspects A21-A28, wherein the sealed glass package has a burst pressure greater than or equal to 500 kPa.

A thirtieth aspect A30 includes the method according to any one of the twenty-first through twenty-ninth aspects A21-A29, wherein at least one of the first laser bond and the second laser bond is contiguous along a perimeter of the sealed glass package.

A thirty-first aspect A31 includes the method according to any one of the twenty-first through thirtieth aspects A21-A30, wherein at least one of the first laser bond and the second laser bond is discontinuous along a perimeter of the sealed glass package.

A thirty-second aspect A32 includes the method according to any one of the twenty-first through thirty-first aspects A21-A31, wherein at least one of the first laser bond and the second laser bond comprises a width greater than or equal to 8 µm and less than or equal to 500 µm.

A thirty-third aspect A33 includes the method according to any one of the twenty-first through thirty-second aspects A21-A32, wherein the polymer is in a form of an O-ring.

A thirty-fourth aspect A34 includes the method according to any one of the twenty-first through thirty-third aspects A21-A33, wherein, prior to contacting the top substrate and the central substrate, the polymer comprises a thickness greater than or equal to 0.1 mm and less than or equal to 1 mm.

A thirty-fifth aspect A35 includes the method according to any one of the twenty-first through thirty-fourth aspects A21-A34, wherein the polymer comprises the polymer comprises fluoroelastomer, nitrile rubber, silicone, butadiene, neoprene, polydimethylsiloxane, or a combination thereof.

A thirty-sixth aspect A36 includes the method according to any one of the twenty-first through thirty-fifth aspects A21-A35, wherein the polymer comprises a loss coefficient tan(δ) greater than or equal to 0.1 a Young’s modulus E less than or equal to 2000 MPa, and a sound absorption coefficient α greater than or equal to 0.5.

A thirty-seventh aspect A37 includes the method according to any one of the twenty-first through thirty-sixth aspects A21-A36, wherein the polymer comprises fillers, the fillers comprising nanofillers, hollow glass spheres, or a combination thereof.

A thirty-eighth aspect A38 includes the method according to the thirty-seventh aspect A37, wherein the nanofillers comprise carbon nanotubes.

A thirty-ninth aspect A39 includes the method according to any one of the twenty-first through thirty-eighth aspects A21-A38, wherein the polymer comprises a roughened outer surface having a tortuosity greater than 1.

A fortieth aspect A40 includes the method according to any one of the twenty-first through thirty-ninth aspects A21-A39, wherein the top substrate comprises a groove within which the polymer sits.

A forty-first aspect A41 includes the method according to any one of the twenty-first through fortieth aspects A21-A40, wherein the top substrate and the bottom substrate each comprise a thickness greater than or equal to 100 µm and less than or equal to 700 µm.

A forty-second aspect A42 includes the method according to any one of the twenty-first through forty-first aspects A21-A41, wherein the central substrate comprises a thickness greater than or equal to 0.5 mm and less than or equal to 1.3 mm.

A forty-third aspect A43 includes the method according to any one of the twenty-first through forty-second aspects A21-A42, wherein the sealed glass package comprises a thickness from the first major surface of the top substrate to the second major surface of the bottom substrate greater than or equal to 0.3 mm and less than or equal to 10 mm.

A forty-fourth aspect A44 includes the method according to any one of the twenty-first through forty-third aspects A21-A43, wherein the top substrate, the bottom substrate, and the central substrate comprise a glass or glass-ceramic comprising borate glass, silicoborate glass, phosphate-based glass, silicon carbide glass, soda-lime silicate glass, aluminosilicate glass, alkali-aluminosilicate glass, borosilicate glass, alkali-borosilicate glass, aluminoborosilicate glass, alkali-alumino-borosilicate glass, or alkali-aluminosilicate glass.

A forty-fifth aspect A45 includes the method according to any one of the twenty-first through forty-fourth aspects A21-A44, wherein the sealed glass package comprises a liquid lens.

Additional features and advantages of the sealed glass packages described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a schematic, cross-sectional view of an exemplary liquid lens, according to one or more embodiments shown and described herein;

FIG. 2 is a schematic, cross-sectional view of another exemplary liquid lens, according to one or more embodiments shown and described herein;

FIG. 3 is a flow diagram of a method of forming a liquid lens, according to one or more embodiments shown and described herein;

FIG. 4 schematically depicts a step of the liquid lens forming method, according to one or more embodiments shown and described herein;

FIG. 5 schematically depicts another step of the liquid lens forming method, according to one or more embodiments shown and described herein;

FIG. 6 schematically depicts another step of the liquid lens forming method, according to one or more embodiments shown and described herein;

FIG. 7 schematically depicts another step of the liquid lens forming method, according to one or more embodiments shown and described herein;

FIG. 8 schematically depicts another step of the liquid lens forming method, according to one or more embodiments shown and described herein;

FIG. 9 schematically depicts another step of the liquid lens forming method, according to one or more embodiments shown and described herein;

FIG. 10 schematically depicts a well glass plate;

FIG. 11 schematically depicts a side-view of the well glass place of FIG. 10 with an O-ring being disposed therein, according to one or more embodiments shown and described herein;

FIG. 12 is a photograph of a well glass place with an O-ring disposed therein, according to one or more embodiments shown and described herein; and

FIG. 13 is a photograph of a well glass place with an O-ring disposed therein, according to one or more embodiments shown and described herein.

### DETAILED DESCRIPTION

Reference will now be made in detail to various embodiments of sealed glass packages having sufficient burst pressure and high yield methods of making same. According to embodiments, a sealed glass package includes a top substrate and a bottom substrate, each of the top substrate and the bottom substrate comprising a first major surface and a second major surface opposite the first major surface; a central substrate disposed between the second major surface of the top substrate and the first maj or surface of the bottom substrate, the central substrate including a cavity filled by a first liquid and a second liquid; a polymer disposed between the second major surface of the top substrate and the central substrate; a first laser bond joining and hermetically sealing the first major surface of the bottom substrate and the central substrate; and a second laser bond joining and hermetically sealing the second major surface of the top substrate and the central substrate. Various embodiments of sealed glass packages and methods of making same will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein - for example up, down, right, left, front, back, top, bottom - are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

“Hermetic bond” or “hermetic seal,” as described herein, refers to a package that includes a hermetic seal in accordance with MIL-STD-750E, Test Method 1071.9.

“Burst pressure,” as described herein, is measured in accordance with ASTM F1140.

Sealed glass packages may be utilized for a wide range of applications, including autofocus, optical zoom, and optical image stabilization functions. For example, a liquid lens incorporates a first liquid and a second liquid that are relatively immiscible with each other and have different indices of refraction for electromagnetic radiation of one or more relevant wavelengths. The first liquid and the second liquid form a meniscus (interface) that manipulates incident electromagnetic radiation of the one or more relevant wavelengths, such as to facilitate sensing of the electromagnetic radiation. The shape and position of the meniscus may be altered using principles of electrowetting.

Substrates surround and encapsulate the first liquid and the second liquid, preventing those liquids from escaping the sealed glass package. Conventional laser bonding techniques may provide hermetic bonding for the sealed glass package, but the yield of these methods depends on inadvertent particulates (e.g., airborne particulates) being introduced in the region to be welded. Other conventional bonding methods may use a polymer to form a hermetically sealed glass package, but may require small metal enclosures to press-fit the substrates together and may not be amenable to large scale production.

Disclosed herein are sealed glass packages which mitigate the aforementioned problems such that sealed glass package has sufficient burst pressure (e.g., greater than or equal to 500 kPa) and is formed using a high yield method. Specifically, the sealed glass packages disclosed herein include both a polymer and a laser bond. The polymer may provide tolerance for sealing the substrates in the presence of particulates. Laser bonding to seal the substrates eliminates the need for metal enclosures to press-fit the substrates together and may be easily incorporated to produce sealed glass packages in a relatively fast, large-scale manner.

For simplicity and clarity, the discussion below is directed to a liquid lens. However, one skilled in the art will appreciate that the embodiments described herein may be directed to any sealed glass package comprising a top substrate; a bottom substrate; a central substrate disposed between the top substrate and the bottom substrate, the central substrate including a cavity filled by a first liquid and a second liquid; a polymer disposed between the top substrate and the central substrate; a first laser bond joining and hermetically sealing the bottom substrate and the central substrate; and a second laser bond joining and hermetically sealing the second major surface of the top substrate and the central substrate.

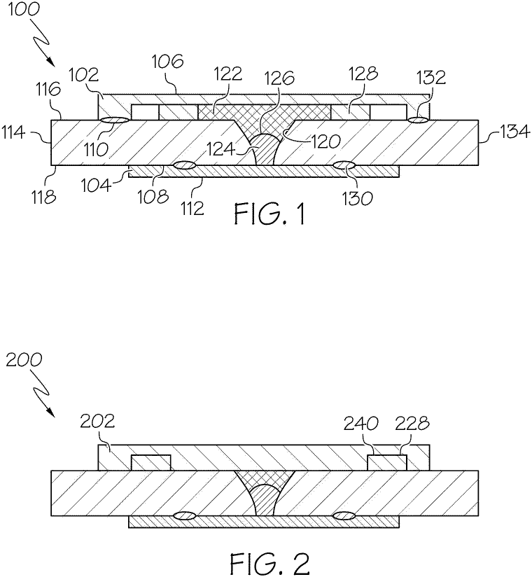

Referring now to FIG. 1, a liquid lens 100 comprises a top substrate 102 and a bottom substrate 104. Each of the top substrate 102 and the bottom substrate 104 comprise a first major surface 106, 108 and a second major surface 110, 112 opposite the first major surface 106, 108. A central substrate 114 is disposed between the second major surface 110 of the top substrate 102 and the first major surface 108 of the bottom substrate 104. The central substrate 114 comprises a first major surface 116 and a second major surface 118 opposite the first major surface 116.

In embodiments, the top substrate 102 and the bottom substrate 104 each may comprise a thickness greater than or equal to 100 µm and less than or equal to 700 µm. In embodiments, the top substrate 102 and the bottom substrate 104 each may comprise a thickness greater than or equal to 100 µm, greater than or equal to 200 µm, or even greater than or equal to 300 µm. In embodiments, the top substrate 102 and the bottom substrate 104 each may comprise a thickness less than or equal to 700 µm, less than or equal to 600 µm, or even less than or equal to 500 µm. In embodiments, the top substrate 102 and the bottom substrate 104 each may comprise a thickness greater than or equal to 100 µm and less than or equal to 700 µm, greater than or equal to 100 µm and less than or equal to 600 µm, greater than or equal to 100 µm and less than or equal to 500 µm, greater than or equal to 200 µm and less than or equal to 700 µm, greater than or equal to 200 µm and less than or equal to 600 µm, greater than or equal to 200 µm and less than or equal to 500 µm, greater than or equal to 300 µm and less than or equal to 700 µm, greater than or equal to 300 µm and less than or equal to 600 µm, or even greater than or equal to 300 µm and less than or equal to 500 µm, or any and all sub-ranges formed from any of these endpoints.

In embodiments, the central substrate 114 may comprise a thickness greater than or equal to 500 µm and less than or equal to 1300 µm. In embodiments, the central substrate 114 may comprise a thickness greater than or equal to 500 µm, greater than or equal to 600 µm, or even greater than or equal to 700 µm. In embodiments, the central substrate 114 may comprise a thickness less than or equal to 1300 µm, less than or equal to 1200 µm, less than or equal to 1100 µm, or even less than or equal to 1000 µm. In embodiments, the central substrate 114 may comprise a thickness greater than or equal to 500 µm and less than or equal to 1300 µm, greater than or equal to 500 µm and less than or equal to 1200 µm, greater than or equal to 500 µm and less than or equal to 1100 µm, greater than or equal to 500 µm and less than or equal to 1000 µm, greater than or equal to 600 µm and less than or equal to 1300 µm, greater than or equal to 600 µm and less than or equal to 1200 µm, greater than or equal to 600 µm and less than or equal to 1100 µm, greater than or equal to 600 µm and less than or equal to 1000 µm, greater than or equal to 700 µm and less than or equal to 1300 µm, greater than or equal to 700 µm and less than or equal to 1200 µm, greater than or equal to 700 µm and less than or equal to 1100 µm, or even greater than or equal to 700 µm and less than or equal to 1000 µm, or any and all sub-ranges formed from any of these endpoints.

In embodiments, the liquid lens 100 may comprise a thickness from the first major surface 106 of the top substrate 102 to the second major surface 112 of the bottom substrate 104 greater than or equal to 0.3 mm and less than or equal to 10 mm. In embodiments, the liquid lens 100 may comprise a thickness from the first major surface 106 of the top substrate 102 to the second major surface 112 of the bottom substrate 104 greater than or equal to 0.3 mm, greater than or equal to 0.5 mm, greater than or equal to 0.7 mm, or even greater than or equal to 1 mm. In embodiments, the liquid lens 100 may comprise a thickness from the first major surface 106 of the top substrate 102 to the second major surface 112 of the bottom substrate 104 less than or equal to 10 mm, less than or equal to 8 mm, less than or equal to 6 mm, less than or equal to 4 mm, or even less than or equal to 2 mm. In embodiments, the liquid lens 100 may comprise a thickness from the first major surface 106 of the top substrate 102 to the second major surface 112 of the bottom substrate 104 greater than or equal to 0.3 mm and less than or equal to 10 mm, greater than or equal to 0.3 mm and less than or equal to 8 mm, greater than or equal to 0.3 mm and less than or equal to 6 mm, greater than or equal to 0.3 mm and less than or equal to 4 mm, greater than or equal to 0.3 mm and less than or equal to 2 mm, greater than or equal to 0.5 mm and less than or equal to 10 mm, greater than or equal to 0.5 mm and less than or equal to 8 mm, greater than or equal to 0.5 mm and less than or equal to 6 mm, greater than or equal to 0.5 mm and less than or equal to 4 mm, greater than or equal to 0.5 mm and less than or equal to 2 mm, greater than or equal to 0.7 mm and less than or equal to 10 mm, greater than or equal to 0.7 mm and less than or equal to 8 mm, greater than or equal to 0.7 mm and less than or equal to 6 mm, greater than or equal to 0.7 mm and less than or equal to 4 mm, greater than or equal to 0.7 mm and less than or equal to 2 mm, greater than or equal to 1 mm and less than or equal to 10 mm, greater than or equal to 1 mm and less than or equal to 8 mm, greater than or equal to 1 mm and less than or equal to 6 mm, greater than or equal to 1 mm and less than or equal to 4 mm, or even greater than or equal to 1 mm and less than or equal to 2 mm, or any and all sub-ranges formed from any of these endpoints.

In embodiments, the top, bottom, and central substrates 102, 104, 114 may comprise a glass or a glass-ceramic. By way of non-limiting examples, the top, bottom, and central substrates 102, 104, 114 may comprise borate glass, silicoborate glass, phosphate-based glass, silicon carbide glass, soda-lime silicate glass, aluminosilicate glass, alkali-aluminosilicate glass, borosilicate glass, alkali-borosilicate glass, aluminoborosilicate glass, alkali-alumino-borosilicate glass, or alkali-aluminosilicate glass.

In embodiments, the top and bottom substrates 102, 104 may be formed from a material that is substantially transparent to a selected wavelength of a laser beam. The term “substantially transparent” means that a wavelength of a laser beam transmits through the material without being substantially absorbed or scattered. For example, in embodiments, a material that is substantially transparent to a wavelength of a laser beam may be a material that exhibits a transmittance greater or equal to 90% at the wavelength. In embodiments, the top and bottom substrates 102, 104 may be substantially transparent to a wavelength of light greater than or equal to 300 nm and less than or equal to 1100 nm or even greater than or equal to 330 nm and less than or equal to 750 nm.

The central substrate 114 comprises a cavity 120 filled by a first liquid 122 and a second liquid 124. In embodiments, the first liquid 122 and the second liquid 124 may be substantially immiscible such that a fluid interface 126, when curved, may refract light with optical power as a lens. In embodiments, the first liquid 122 may be electrically conductive, and the second liquid 124 may be electrically insulating. In embodiments, the first liquid 122 may be a polar fluid, such as an aqueous solution. In embodiments, the second liquid 124 may be an oil. In embodiments, the first liquid 122 may have a higher dielectric constant than the second liquid 124. In embodiments, the first liquid 122 and the second liquid 124 may have different indices of refraction so that light may be refracted as it passes through the fluid interface 126. In embodiments, the first liquid 122 and the second liquid 124 may have substantially similar densities, which may impede either of the liquids 122, 124 from floating relative to the other.

In embodiments, the cavity 120 may include curved side walls as shown in FIG. 1. In embodiments, the side walls may conform to the shape of a portion of a sphere, toroid, or other geometric shape. In embodiments, the cavity 120 may have a narrow portion where the side walls are closer together and a wide portion where the side walls are further apart. The narrow portion may be at the bottom end of the cavity 120 and the wide portion may be at the top end of the cavity 120 in the orientation shown in FIG. 1, although the liquid lenses 100 disclosed herein may be positioned in various other orientations. In embodiments, the edge of the fluid interface 126 may contact the curved side walls of the cavity 120. Various other cavity shapes may be used. For example, in embodiments, the cavity 120 may have a shape of a frustum or truncated cone. In embodiments, the cavity 120 may have angled side walls.

A polymer 128 is disposed between the second major surface 110 of the top substrate 102 and the central substrate 114. As described herein, the polymer 128 may provide tolerance for sealing in the presence of particulates to achieve a hermetic seal.

In embodiments, the polymer 128 may be in a state of compression, forming a seal between the top substrate 102 and the central substrate 114 such that the seal limits permeation to a water vapor transmission ratio to less than 0.1 gm/m²/day as measured according to ASTM F3299. In embodiments, in the state of compression, the polymer 128 may have a thickness less than or equal to 200 µm, less than or equal to 150 µm, less than or equal to 100 µm, or even less than or equal to 50 µm.

In embodiments, the polymer 128 may be continuous. In embodiments, the polymer 128 may be in the form of an O-ring. In embodiments, the polymer 128 may comprise an elastomer polymer. The term “elastomer,” as used herein refers to amorphous polymer that when operating above its glass transition temperature Tg, the polymer exhibits an elasticity which may reversibly extend from 700%. By way of non-limiting examples, the polymer 128 may comprise fluoroelastomer (e.g., Viton ™), nitrile rubber, silicone, butadiene, neoprene, polydimethylsiloxane, or a combination thereof. In embodiments, the polymer 128 may comprise an elastomer that “wets” glass surfaces, such polydimethylsiloxane.

In embodiments, the properties of the polymer 128 (e.g., loss coefficient tan(δ), Young’s modulus E, and sound absorption coefficient) may be selected to increase damping and isolate vibration to prevent damaging resonant, such as those induced by dropping a liquid lens on the ground. In embodiments, the polymer 128 may comprise a loss coefficient tan(δ) greater than or equal to 0.1. In embodiments, the polymer 128 may comprise Young’s modulus E less than or equal to 2000 MPa. In embodiments, the polymer 128 may comprise a sound absorption coefficient α greater than or equal to 0.5.

In embodiments, the polymer 128 may comprise fillers to help increase damping. In embodiments, the fillers may comprise nanofillers, hollow glass spheres, or a combination thereof. In embodiments, the nanofillers may comprise carbon nanotubes.

In embodiments, the polymer 128 may comprise a roughened outer surface having a tortuosity greater than 1 to help increasing damping. The term “tortuosity,” as used herein, is an intrinsic property of a porous material and is defined as the ratio of L, the propagated length from initial surface to the interior solid polymer region, to C, the direct line distance from initial surface to the interior solid polymer region. When tortuosity is greater than 1, surface interactions become more prominent, promoting surface adsorption interactions, which effectively damps further acoustic perturbation ingress.

A first laser bond 130 joins and hermetically seals the first major surface 108 of the bottom substrate 104 and the central substrate 114. A second laser bond 132 joins and hermetically seals the second major surface 110 of the top substrate 102 and the central substrate 114.

In embodiments, at least one of the first laser bond 130 and the second laser bond 132 may be continuous along a perimeter 134 of the liquid lens 100. In embodiments, at least one of the first laser bond 130 and the second laser bond 132 may be discontinuous along a perimeter 134 along a perimeter 134 of the liquid lens 100.

In embodiments, at least one of the first laser bond 130 and the second laser bond 132 may comprise a width greater than or equal to 8 µm and less than or equal to 500 µm. In embodiments, at least one of the first laser bond 130 and the second laser bond 132 may comprise a width greater than or equal to 8 µm, greater than or equal to 20 µm, greater than or equal to 40 µm, greater than or equal to 60 µm, or even greater than or equal to 80 µm. In embodiments, at least one of the first laser bond 130 and the second laser bond 132 may comprise a width less than or equal to 500 µm, less than or equal to 250 µm, or even less than or equal to 125 µm. In embodiments, at least one of the first laser bond 130 and the second laser bond 132 may comprise a width greater than or equal to 8 µm and less than or equal to 500 µm, greater than or equal to 8 µm and less than or equal to 250 µm, greater than or equal to 8 µm and less than or equal to 120 µm, greater than or equal to 20 µm and less than or equal to 500 µm, greater than or equal to 20 µm and less than or equal to 250 µm, greater than or equal to 20 µm and less than or equal to 120 µm, greater than or equal to 40 µm and less than or equal to 500 µm, greater than or equal to 20 µm and less than or equal to 250 µm, greater than or equal to 40 µm and less than or equal to 120 µm, greater than or equal to 60 µm and less than or equal to 500 µm, greater than or equal to 60 µm and less than or equal to 250 µm, greater than or equal to 60 µm and less than or equal to 120 µm, greater than or equal to 80 µm and less than or equal to 500 µm, greater than or equal to 80 µm and less than or equal to 250 µm, or even greater than or equal to 80 µm and less than or equal to 120 µm, or any and all sub-ranges formed from any of these endpoints.

As described herein, laser bonds 130, 132, along with the polymer 128 help provide a liquid lens 100 having a hermetic seal and a sufficient burst pressure (e.g., greater than or equal to 500 kPa). In embodiments, the liquid lens 100 may comprise a burst pressure greater than or equal to 500 kPa, greater than or equal to 600 kPa, or even greater than or equal to 700 kPa.

Referring now to FIG. 2, in embodiments, a liquid lens 200 may comprise a top substrate 202 having a groove 240 within which a polymer 228 is positioned.

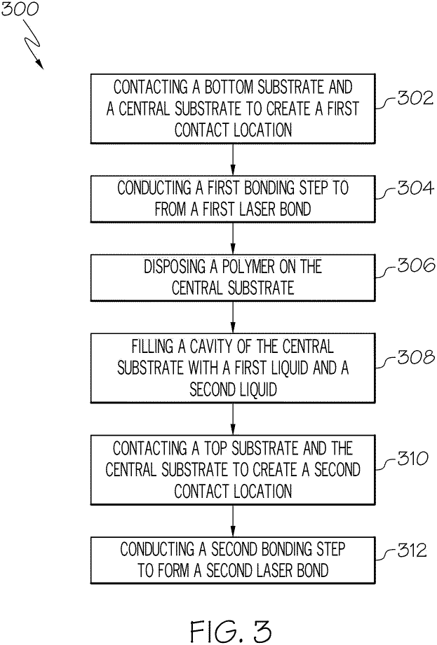

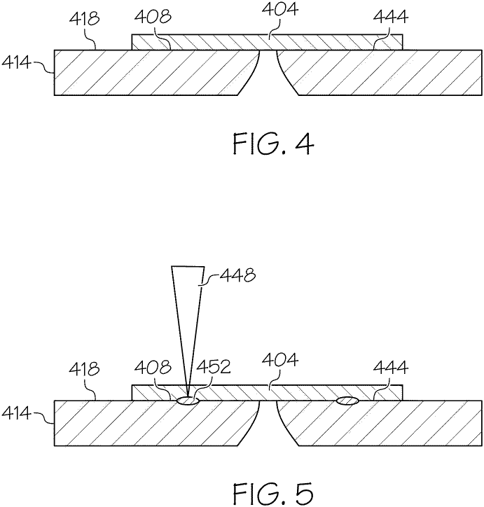

Referring now to FIG. 3, a method of forming a liquid lens as described herein is shown at 300. The method 300 begins at block 302 with contacting a first major surface 408 of a bottom substrate 404 with a second major surface 418 of a central substrate 414. The contacting of the bottom substrate 404 and the central substrate 414 creates a first contact location 444 between at least a portion of the first major surface 408 of the bottom substrate 404 and the second major surface 418 of the central substrate 414 as shown in FIG. 4.

Referring back to FIG. 3 and now to FIG. 5, the method 300 continues at block 304 with conducting a first bonding step by directing a laser beam 448 on at least a portion of the first contact location 444 to bond the bottom substrate 404 to the central substrate 414 and form a first laser bond 452. The first laser bond 452 joins and hermetically seals the first major surface 408 of the bottom substrate 404 and the second major surface 418 of the central substrate 414.

A wide range of laser beam and welding conditions may be suitable for laser bonding to form the liquid lenses described herein. Such laser bonding conditions and the resulting bond properties are described in U.S. Pat. No. 9,515,286 B2; U.S. Pat. No. US 9,666,763 B2; U.S. Pat. No. 9,741,963 B2; U.S. Pat. No. 9,761,828 B2; U.S. Pat. No. US 10,011,525 B2; U.S. Pat. No. 10,069,104 B2; U.S. Pat. No. 10,283,731 B2; U.S. Pat. No. 10,345,533 B1; U.S. Pat. No. 10,422,961 B2; U.S. Pat. No. 10,457,595 B2; U.S. Pat. No. 10,497,898 B2; U.S. Pat. No. 10,545,293 B2; U.S. Pat. No. 10,746,937 B2; and U.S. Pat. No. 10,858,283 B2, which are incorporated by reference herein in their entireties.

For example, in embodiments, the laser beam 448 may have a spot size greater than or equal to 10 µm and less than or equal to 200 µm. In embodiments, the laser beam 448 may have a spot size greater than or equal to 10 µm, greater than or equal to 25 µm, or even greater than or equal to 50 µm. In embodiments, the laser beam 448 may have a spot size less than or equal to 200 µm, less than or equal to 150 µm, or even less than or equal to 100 µm. In embodiments, the laser beam 448 may have a spot size greater than or equal to 10 µm and less than or equal to 200 µm, greater than or equal to 10 µm and less than or equal to 150 µm, greater than or equal to 10 µm and less than or equal to 100 µm, greater than or equal to 25 µm and less than or equal to 200 µm, greater than or equal to 25 µm and less than or equal to 150 µm, greater than or equal to 25 µm and less than or equal to 100 µm, greater than or equal to 50 µm and less than or equal to 200 µm, greater than or equal to 50 µm and less than or equal to 150 µm, or even greater than or equal to 50 µm and less than or equal to 100 µm, or any and all sub-ranges formed from any of these endpoints.

In embodiments, the laser beam 448 may have a speed of beam translation greater than or equal to 20 mm/s and less than or equal to 1 m/s. In embodiments, the laser beam 448 may have a speed of beam translation greater than or equal to 20 mm/s, greater than or equal to 50 mm/s, greater than or equal to 100 mm/s, or even greater than or equal to 250 mm/s. In embodiments, the laser beam 448 may have a speed of beam translation less than or equal to 1 m/s, less than or equal to 750 mm/s, or even less than or equal to 500 mm/s. In embodiments, the laser beam 448 may have a speed of beam translation greater than or equal to 20 mm/s and less than or equal to 1 m/s, greater than or equal to 20 mm/s and less than or equal to 750 mm/s, greater than or equal to 20 mm/s and less than or equal to 500 mm/s, greater than or equal to 50 mm/s and less than or equal to 1 m/s, greater than or equal to 50 mm/s and less than or equal to 750 mm/s, greater than or equal to 50 mm/s and less than or equal to 500 mm/s, greater than or equal to 100 mm/s and less than or equal to 1 m/s, greater than or equal to 100 mm/s and less than or equal to 750 mm/s, greater than or equal to 100 mm/s and less than or equal to 500 mm/s, greater than or equal to 250 mm/s and less than or equal to 1 m/s, greater than or equal to 250 mm/s and less than or equal to 750 mm/s, or even greater than or equal to 250 mm/s and less than or equal to 500 mm/s, or any and all sub-ranges formed from any of these endpoints.

In embodiments, the laser beam 448 may have a laser power greater than or equal to 10 mW and less than or equal to 3 W. In embodiments, the laser beam 448 may have a laser power greater than or equal to 10 mW, greater than or equal to 50 mW, greater than or equal to 100 mW, or even greater than or equal to 500 mW. In embodiments, the laser beam 448 may have a laser power less than or equal to 3 W, less than or equal to 2 W, or even less than or equal to 1 W. In embodiments, the laser beam 448 may have a laser power greater than or equal to 10 mW and less than or equal to 3 W, greater than or equal to 10 mW and less than or equal to 2 W, greater than or equal to 10 mW and less than or equal to 1 W, greater than or equal to 50 mW and less than or equal to 3 W, greater than or equal to 50 mW and less than or equal to 2 W, greater than or equal to 50 mW and less than or equal to 1 W, greater than or equal to 100 mW and less than or equal to 3 W, greater than or equal to 100 mW and less than or equal to 2 W, greater than or equal to 100 mW and less than or equal to 1 W, greater than or equal to 500 mW and less than or equal to 3 W, greater than or equal to 500 mW and less than or equal to 2 W, or even greater than or equal to 500 mW and less than or equal to 1 W, or any and all sub-ranges formed from any of these endpoints.

In embodiments, the laser beam 448 may comprise a continuous wave laser. In embodiments, the laser beam 448 may comprise a pulsed laser. In embodiments, the pulsed laser may have a repetition rate greater than or equal to 1 kHz and less than or equal to 1 MHz. In embodiments, the pulsed laser may have a repetition rate greater than or equal to 1 kHz, greater than or equal to 50 kHz, greater than or equal to 100 kHz, or even greater than or equal to 250 kHz. In embodiments, the pulsed laser may have a repetition rate less than or equal to 1 MHz, less than or equal to 750 kHz, or even less than or equal to 500 kHz. In embodiments, the pulsed laser may have a repetition rate greater than or equal to 1 kHz and less than or equal to 1 MHz, greater than or equal to 1 kHz and less than or equal to 750 kHz, greater than or equal to 1 kHz and less than or equal to 500 kHz, greater than or equal to 50 kHz and less than or equal to 1 MHz, greater than or equal to 50 kHz and less than or equal to 750 kHz, greater than or equal to 50 kHz and less than or equal to 500 kHz, greater than or equal to 100 kHz and less than or equal to 1 MHz, greater than or equal to 100 kHz and less than or equal to 750 kHz, greater than or equal to 100 kHz and less than or equal to 500 kHz, greater than or equal to 250 kHz and less than or equal to 1 MHz, greater than or equal to 250 kHz and less than or equal to 750 kHz, or even greater than or equal to 250 kHz and less than or equal to 500 kHz, or any and all sub-ranges formed from any of these endpoints.

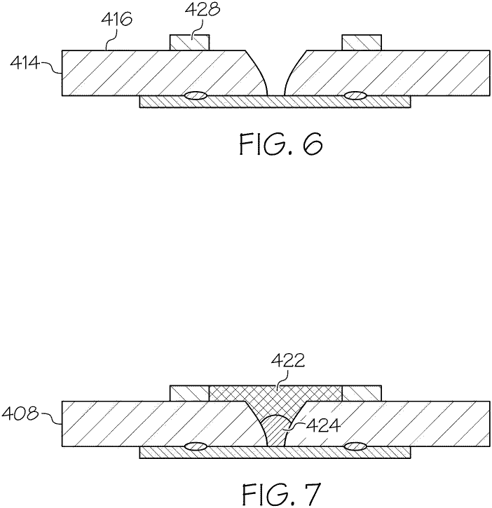

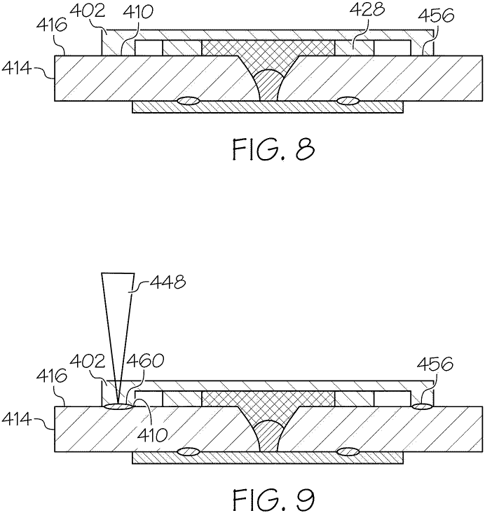

Referring back to FIG. 3 and now to FIG. 6, the method 300 continues at block 306 with disposing a polymer 428 on a first major surface 416 of the central substrate 414. In embodiments, the polymer 428 may be applied as a single component (e.g., an O-ring). In embodiments, the polymer 428 may be applied and cured. In embodiments, upon disposal or application and prior to contacting a top substrate 402 with the central substrate 414 as described below, the polymer 428 may comprise a thickness greater than or equal to 0.1 mm and less than or equal to 1 mm, greater than or equal to 0.1 mm and less than or equal to 0.8 mm, greater than or equal to 0.1 mm and less than or equal to 0.6 mm, greater than or equal to 0.3 mm and less than or equal to 1 mm, greater than or equal to 0.3 mm and less than or equal to 0.8 mm, or even greater than or equal to 0.3 mm and less than or equal to 0.6 mm, or any and all sub-ranges formed from any of these endpoints.

Referring back to FIG. 3 and now to FIG. 7, the method 300 continues at block 308 with filling a cavity 420 of the central substrate 414 with a first liquid 422 and a second liquid 424.

Referring back to FIG. 3 and now to FIG. 8, the method 300 continues at block 310 with contacting a second major surface 410 of a top substrate 402 with the first major surface 416 of the central substrate 414. The contacting of the top substrate 4402 and the central substrate 414 creates a second contact location 456 between at least a portion of the second major surface 410 of the top substrate 402 and the first maj or surface 416 of the central substrate 414. In embodiments, during contacting the second major surface 410 of the top substrate 402 with the first major surface 416 of the central substrate 414, the polymer 428 may be compressed.

Referring back to FIG. 3 and now to FIG. 9, the method 300 continues at block 312 with conducting a second bonding step by directing the laser beam 448 on at least a portion of the second contact location 456 to bond the top substrate 402 to the central substrate 414 and form a second laser bond 460 joining and hermetically sealing the second major surface 410 of the top substrate 402 and the first major surface 416 of the central substrate 414. The laser beam 448 of the second bonding step may have similar parameters as the laser beam 448 of the first bonding step as described herein.

### EXAMPLES

In order that various embodiments be more readily understood, reference is made to the following examples, which illustrate various embodiments of the liquid lenses described herein.

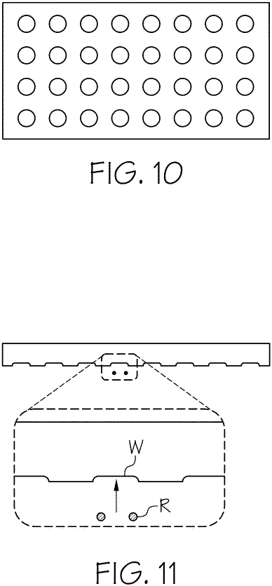

Referring now to FIG. 10, a 24-well glass plate was used to demonstrate hermetic sealing. Each well had a diameter of 5 mm and a depth of 200 µm. Referring now to FIG. 11, an O-ring R was placed within one of the wells W. The O-ring R had an outer diameter of 7 mm.

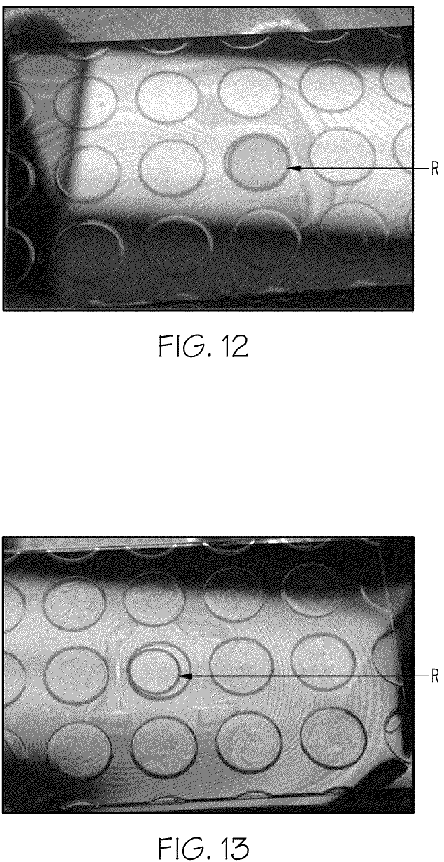

Referring now to FIG. 12, in one example, the wells were filled with water and a top substrate was applied to the well plate. The well W with the O-ring R therein was laser bonded at four points about its periphery. The well plate was heated in an 85° C. oven for 48 hours and analyzed for sign of water loss. The initially filled water in well W was still intact.

Referring now to FIG. 13, in another example, a top substrate was applied to the well plate. The well W with the O-ring R therein was laser bonded at four points about its periphery. The well plate was immersed in an 85° C. water bath for 48 hours and analyzed for water well-intrusion. The initially sealed air in well W was still intact, while the other wells without the O-ring sustained water intrusion.

As exemplified, the liquid lenses described herein demonstrate hermetic sealing.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A sealed glass package, comprising:
a top substrate and a bottom substrate, each of the top substrate and the bottom substrate comprising a first major surface and a second major surface opposite the first major surface;
a central substrate disposed between the second maj or surface of the top substrate and the first major surface of the bottom substrate, the central substrate including a cavity filled by a liquid;
a polymer disposed between the second major surface of the top substrate and the central substrate;
a first laser bond joining and hermetically sealing the first major surface of the bottom substrate and the central substrate; and
a second laser bond joining and hermetically sealing the second major surface of the top substrate and the central substrate.

2. The sealed glass package of claim 1, wherein the sealed glass package comprises a burst pressure greater than or equal to 500 kPa.

3. The sealed glass package of claim 1, wherein at least one of the first laser bond and the second laser bond comprises a width greater than or equal to 8 µm and less than or equal to 500 µm.

4. The sealed glass package of claim 1, wherein the polymer is in the form of an O-ring.

5. The sealed glass package of claim 1, wherein the polymer is in a state of compression, forming a seal between the top substrate and the central substrate.

6. The sealed glass package of claim 1, wherein the polymer comprises a loss coefficient tan(δ) greater than or equal to 0.1.

7. The sealed glass package of claim 1, wherein the polymer comprises a Young’s modulus E less than or equal to 2000 MPa.

8. The sealed glass package of claim 1, wherein the polymer comprises a sound absorption coefficient α greater than or equal to 0.5.

9. The sealed glass package of claim 1, wherein the polymer comprises fillers, the fillers comprising nanofillers, hollow glass spheres, or a combination thereof.

10. The sealed glass package of claim 9, wherein the nanofillers comprise carbon nanotubes.

11. The sealed glass package of claim 1, wherein the polymer comprises a roughened outer surface having a tortuosity greater than 1.

12. The sealed glass package of claim 1, wherein the top substrate comprises a groove within which the polymer is positioned.

13. The sealed glass package of claim 1, wherein the top substrate and the bottom substrate each comprise a thickness greater than or equal to 100 µm and less than or equal to 700 µm.

14. The sealed glass package of claim 1, wherein the central substrate comprises a thickness greater than or equal to 500 µm and less than or equal to 1300 µm.

15. The sealed glass package of claim 1, wherein the sealed glass package comprises a thickness from the first major surface of the top substrate to the second major surface of the bottom substrate greater than or equal to 0.3 mm and less than or equal to 10 mm.

16. The sealed glass package of claim 1, wherein the top substrate, the bottom substrate, and the central substrate comprise a glass or glass-ceramic comprising borate glass, silicoborate glass, phosphate-based glass, silicon carbide glass, soda-lime silicate glass, aluminosilicate glass, alkali-aluminosilicate glass, borosilicate glass, alkali-borosilicate glass, aluminoborosilicate glass, alkali-alumino-borosilicate glass, or alkali-aluminosilicate glass.

17. The sealed glass package of claim 1, wherein the sealed glass package comprises a liquid lens, and the liquid comprises a first liquid and a second liquid.

18. A method of forming a sealed glass package, the method comprising:
contacting a first major surface of a bottom substrate with a second major surface of a central substrate to create a first contact location between at least a portion of the first major surface of the bottom substrate and the second maj or surface of the central substrate;
conducting a first bonding step by directing a laser beam on at least a portion of the first contact location to bond the bottom substrate to the central substrate and form a first laser bond joining and hermetically sealing the first major surface of the bottom substrate and the second major surface of the central substrate;
disposing a polymer on a first maj or surface of the central substrate;
filling a cavity of the central substrate with a liquid;
contacting a second major surface of a top substrate with the first major surface of the central substrate to create a second contact location between at least a portion of the second major surface of the top substrate and the first major surface of the central substrate; and
conducting a second bonding step by directing the laser beam on at least a portion of the second contact location to bond the top substrate to the central substrate and form a second laser bond joining and hermetically sealing the second major surface of the top substrate and the first maj or surface central substrate.

19. The method of claim 18, wherein the laser beam has a speed of beam translation greater than or equal to 20 mm/s and less than or equal to 1 m/s.

20. The method of claim 18, wherein the laser beam has a laser power greater than or equal to 10 mW and less than or equal to 3 W.
